(19) United States
(12) Patent Application Publication
(10) Pub. No.: US 2017/0086521 A1
(43) Pub. Date: Mar. 30, 2017

(54) Poly Encased utility knuckle flashlight gloves

(71) Applicant: Justin Corbett Sterner, Mountain, ND (US)

(72) Inventor: Justin Corbett Sterner, Mountain, ND (US)

(21) Appl. No.: 14/864,956

(22) Filed: Sep. 25, 2015

(51) Int. Cl. A41D 19/015; F21V 33/00; F21L 4/00; F21V 31/00; F21V 23/00; F21V 23/04; A41D 19/00; F21V 7/00

(52) U.S. Cl. CPC A41D 19/0157; A41D 19/0051; F21V 33/0008; F21V 7/0066; F21V 7/0075; F21V 31/005; F21V 23/002; F21V 23/0414; F21L 4/00; F21Y 2101/02; F21W 2121/06

(57) ABSTRACT

A waterproof glove that glows in the dark and incorporates an integrated system of illumination devices is disclosed. The glove, to be worn on a user's hand is covered with covered with glow-in-the-dark painted polyurethane and incorporates integrated light-emitting-diodes (LEDs). A first housing is mounted on the exterior of the glove on the second knuckle of each finger and thumb containing an LED light, with a silver-painted reflector located in front of each LED. The glove includes a battery in a waterproofed housing that is connected by wires to an on/off switch that is also connected by wires to each of the LEDs. The pair of gloves may contain magnets on each wrist area to keep them from being separated when not in use. A second embodiment of the apparatus also includes decorative designs of various types made from polyurethane models on the back and/or on fingers of the glove. Another embodiment includes all the features of the second embodiment and additionally includes LEDs and reflectors as part of these designs.

### BACKGROUND OF THE INVENTION

Field of the Invention

This invention relates to the field of work and recreational gloves, and particularly to an illuminated (glow-in-the-dark) glove with integrated Light-emitting-diodes (LEDs).

Description of the Related Art

Many work tasks performed in dark areas require both illumination and dexterity, in situations where it is inconvenient to hold a flashlight and there is no opportunity to mount a light source. In addition, many outdoor recreational and daily life activities such as jogging, biking, walking dogs, camping, hiking, skiing, hunting, and changing a flat tire at night or in low visibility require both focused light and illumination for safety, convenience, and enjoyment.

Various devices have been patented that mount a light source on a user's hand either as part of, in conjunction with, or independent of a glove.

(1) U.S. Pat. No. 6,892,397 B2 to Raz, Olstead and Fitzgerald, entitled “Glove with Integrated Light,” comprises a glove having a palm portion, a back portion, and a knuckle portion, and an electrical circuit that illuminates an illumination device when activated. The glove further comprises a first housing adjacent to the knuckle portion of the glove configured to contain the illuminating device. A second housing adjacent to the back portion of the glove is included and comprises a power source to power the electrical circuit, and a switch that, when activated, activates the electrical circuit thereby supplying power to the illuminating device. Electrical conductors are included to interconnect the first and second housings.

The current invention differs from Raz et alia in having polyurethane rubber encasing the LED lights, wiring, battery housing and an on/off switch to seal and waterproof and to protect the hand from the lights in case of accident. The poly mix includes glow-in-the-dark paint in a range of colors to enhance safety and ease of locating when not being worn. For convenience, magnets in the wrist keep the gloves together when not being worn.

(2) U.S. Pat. No. 7,163,308 to Ferrari and Sommers, entitled “Hand Worn Illuminated Framework,” comprises a framework comprising four or more rope light type LED illumination elements, emanating from a wrist cuff, providing constant, flashing, or sequential illumination, a battery pack, upon the wrist cuff, an index finger mounted switch unit.

The current invention differs from Ferrari in that it is a glove, whereas Ferrari is a framework for wearing upon the hand or over gloves. The current invention does not use rope light elements. The purposes are quite different as Ferrari is primarily for traffic signals, scuba diving and airport ground crews.

(3) US005535105A to Koenen Myers and Trow, entitled “Work Glove and Illuminator Assembly,” comprises a work glove and illuminator. An illuminator is securely mounted on the glove and oriented to project a light beam distally of the glove toward the work surface. The illuminator may have a self-contained light source or utilize fiber optic-transmitted light from a light source remote from the glove. The assembly may comprise a laser generator or may utilize a fiber-optic laser light from a laser generator remote from the glove. The assembly may further comprise a video camera operably attached to a video receiver, a video monitor and/or a video recorder. The assembly is particularly suitable for health care professionals when examining or operating upon an anatomical part of a patient.

The current invention differs from Koenen and Trow. The light in Koenen and Trow comes from the finger tips and has the option of being powered by 2 or 3 power supplies or lasers, being generally for use by health care professionals in examinations or operations.

The LED lights in the current invention are on the knuckles. The invention is for use by workers in hard to see areas or for safety and convenience of recreational users. The poly mix includes glow-in-the-dark paint in a range of colors to enhance safety and ease of finding. For convenience, magnets in the wristbands keep the gloves together when not being worn for convenience.

(4) US007891831B2 to Hui Lin Chen entitled “Self-Illumination Glove,” comprises a self-illumination glove in which the orientation of the light head is adjustable to prevent the light being blocked by the hand movement. The illumination unit includes at least one flexible arm which is extended along and above the dorsum side of the glove body from the power source to the light head and out of the outer glove layer through the through slot, such that the light head is selectively adjusted the orientation when the bendable portion of the flexible arm is adjustably bent.

The current invention differs from Chen. The LED lights are fixed to the top of the hand/knuckle so the area toward which the fingers are aimed is the lighted area and are encased in soft polyurethane rubber to protect the fingers. In addition, the poly mix includes glow-in-the-dark paint in a range of colors to enhance safety and ease of finding.

(5) US007503667B2 to Troy Wilkings, “Lighted Glove” including a front surface and a back surface; an inner area defined between the front and back surfaces, the inner sized to receive a hand of a user; a wrist band sized for transitioning a hand into and out of the inner area; fingers formed between the front surface and back surface, each finger having a base knuckle area, a thumb formed between the front surface and back surface, the thumb having a base knuckle area, the thumb positioned at one end of a row of fingers; crotches between each of the base knuckle areas of the thumb and fingers; at least one light emitting diode positioned on the front surface in the crotch; and wiring joining the light emitting diode to a power source.

The current invention differs from Wilkings. The LED lights are positioned at the 2nd knuckle area, with a silver angled reflector at the 2^{nd} knuckle so the beam of light is aimed directly at the target. The waterproof gloves are encased in poly rubber and have paint mixed into the poly for glow-in-the-dark effect, as well as a magnet at the wrist to connect the two gloves of a pair to prevent loss.

(6) U.S. Pat. No. 6,592,235B1 to Gary Mayo, “Light Emitting Glove,” comprising a glove with a light source attached to it and a switch for turning the light source on and off. The current invention differs from Mayo in the location of the on/off switch, and in using poly rubber to cover the light switch rather than vinyl. It is also waterproof and uses glow-in-the-dark paint in a range of colors to enhance visibility for safety and convenience.

### SUMMARY OF THE INVENTION

One embodiment of an apparatus for illuminating a dark area while maintaining dexterity for work, recreation, or daily life is a waterproofed glove to be worn on the user's hand, covered in glow-in-the-dark painted polyurethane and incorporating integrated light-emitting-diodes (LEDs). A first housing is mounted on the exterior of the glove on the second knuckle of each finger and thumb containing an LED light. A silver-painted reflector is positioned in front of each LED such that when light from the LED hits the reflector, it shines toward where the finger is pointed in order to maximize illumination. The reflector is formed by a little ridge in the polyurethane, creating an angle so as to direct the light toward the target. The glove has slotted cutouts at the first knuckle of each finger to provide flexibility. The glove includes a battery in a waterproofed housing that is connected by wires to an on/off switch that is also connected by wires to each of the LEDs. The pair of gloves may contain magnets on each wrist area to keep them from being separated when not in use.

A second embodiment of the apparatus includes all the features described above and includes decorative designs of various types made from polyurethane models on the back of the glove and/or on fingers of the glove.

Another embodiment includes all the features of the second embodiment includes LEDs and reflectors as part of these designs.

Further features and advantages of the invention will be apparent to those skilled in the art from the following detailed description, taken together with the accompanying drawings.

### BRIEF DESCRIPTION OF THE DRAWINGS

FIG. 1 is an overall view from the top of the glove of one embodiment of the present invention.

FIG. 2 shows the components of the battery box.

FIG. 3 shows the O-rings and LEDs on the first knuckles.

FIG. 4 shows the on/off switch.

FIG. 5 shows the battery box and battery connectors.

FIG. 6 shows the top of the glove with all components, including wires.

FIG. 7 shows the wiring leading to the O-rings and silver reflector.

FIG. 8 shows the silver reflectors.

FIG. 9 shows the positive magnet at the wrist that connects with a negative magnet (FIG. 10) to keep the two gloves together when not in use.

FIG. 10 shows the negative magnet at the wrist that connects with a positive magnet to keep the two gloves together when not in use.

FIG. 11 is a second embodiment of the apparatus showing examples of designs on the first knuckles and back of glove made from polyurethane models including LEDs.

FIG. 12 shows a lizard sitting on a leaf as another example of a design including LEDs on the finger(s) and, in this case, on the back of the glove.

FIG. 13 shows more examples of designs incorporating LEDs, a frog on a leaf on the back of the glove with flower designs on the fingers.

FIG. 14 shows a butterfly with leaves on the back of the glove and fingers as another design incorporating LEDs.

FIG. 15 shows a dragonfly on the back of the glove and fingers as another design incorporating LEDs.

### DETAILED DESCRIPTION OF THE INVENTION

Note: the numbers of the features are the same/consistent in each of the figures (e.g. the glove is always 1, the LEDs 5, etc.), whether repeated in the descriptions or not.

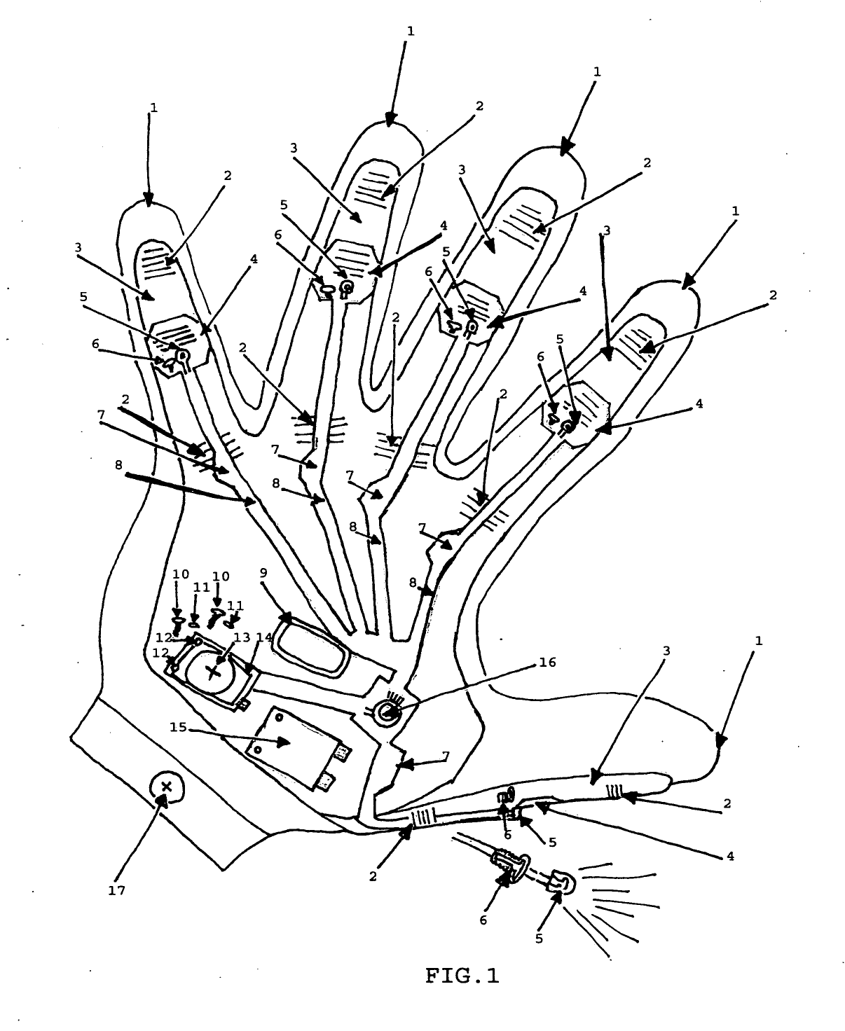

FIG. 1 is an overall view from the top of the glove of one embodiment of the present invention. The glove 1 has three slotted ⅛″ cutouts 2 at the first knuckle of each finger to provide flexibility. The glove is covered in polyurethane 3. Light from the LED 5 at the second knuckle is reflected by a small silver painted reflector 4. When light hits the reflector, it shines toward where the finger is pointed in order to maximize illumination. The reflector is as formed by a little ridge in the polyurethane, creating approximately a 30 degree angle or less to direct the light toward the target. An O-ring rubber gasket with threads 6 screws in over the LED to seal it and ensure it is waterproofed. Wires to the LED run from the off/on switch 16 along a channel 8, which forms a ½″ long x ¼-½″ wide cavity 7 to provide for flexibility adjusting to hand flexing motions. The battery 13 can be one or two CR 2032 button cell lithium batter(ies); two AA or AAA batteries could also be used. The battery fits in a housing 14 with a cover 15; the O-ring gasket 9 goes around the housing to seal and waterproof it. 2 screws 10 fit into holes 12 to connect the cover with the housing; little O-rings 11 provide waterproofing. Magnets 17 on each glove, one positive and one negative, are optional, to facilitate attachment to prevent the gloves from getting separated and lost during storage.

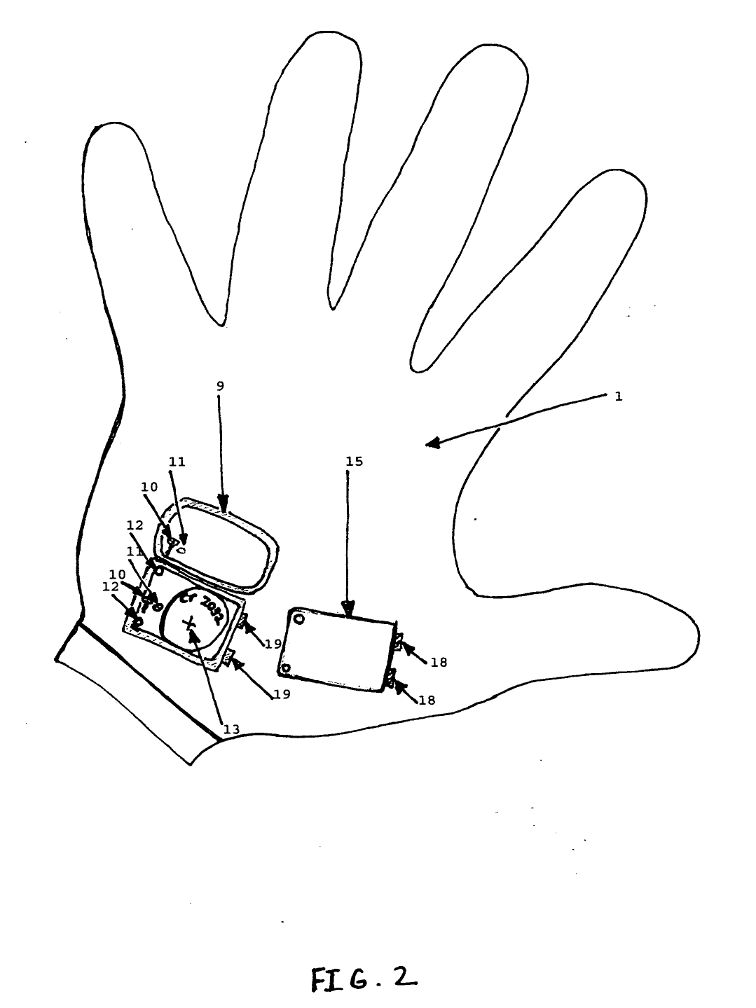

FIG. 2 shows the details of the components of the battery box. As in FIG. 1 the battery 13 can be a CR 2032 button cell lithium battery. The battery fits in a housing 14 with a cover 15; the O-ring gasket 9 goes around the housing to seal and waterproof it. 2 screws 10 fit into holes 12 to connect the cover with the housing; little O-rings 11 provide waterproofing. Plastic pieces 18 on the cover fit into plastic latches on the housing 19 to close it.

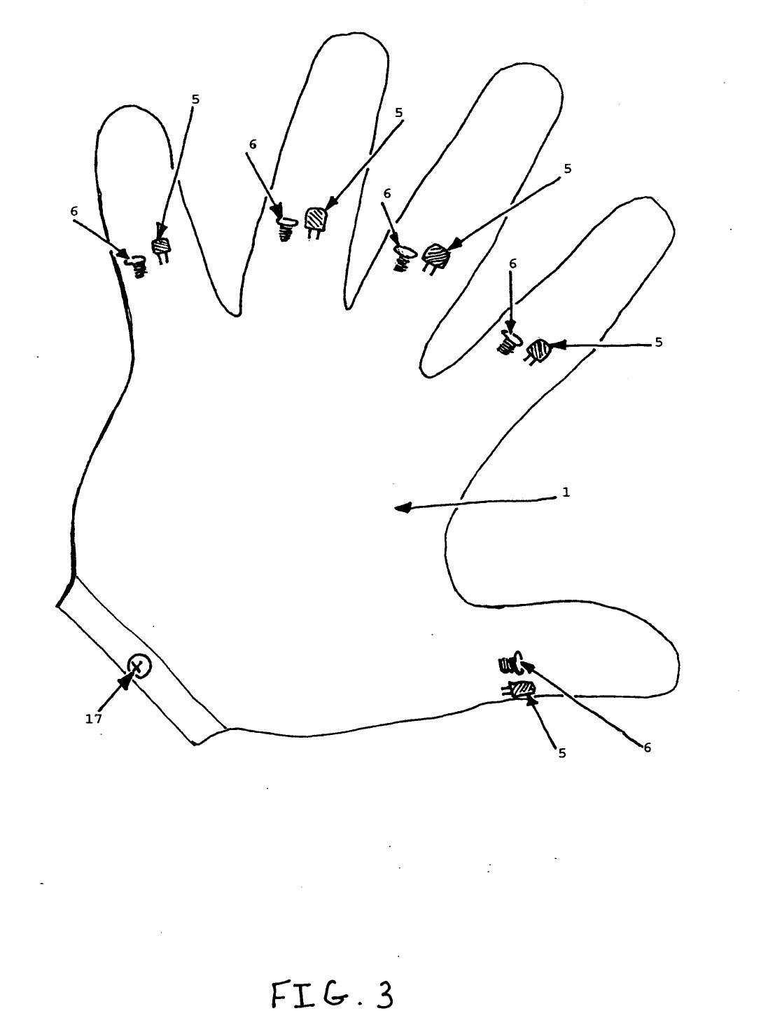

FIG. 3 shows detail of LEDs 5 and O-rings 6 on the second knuckles and the positive magnet 17 at the wristband.

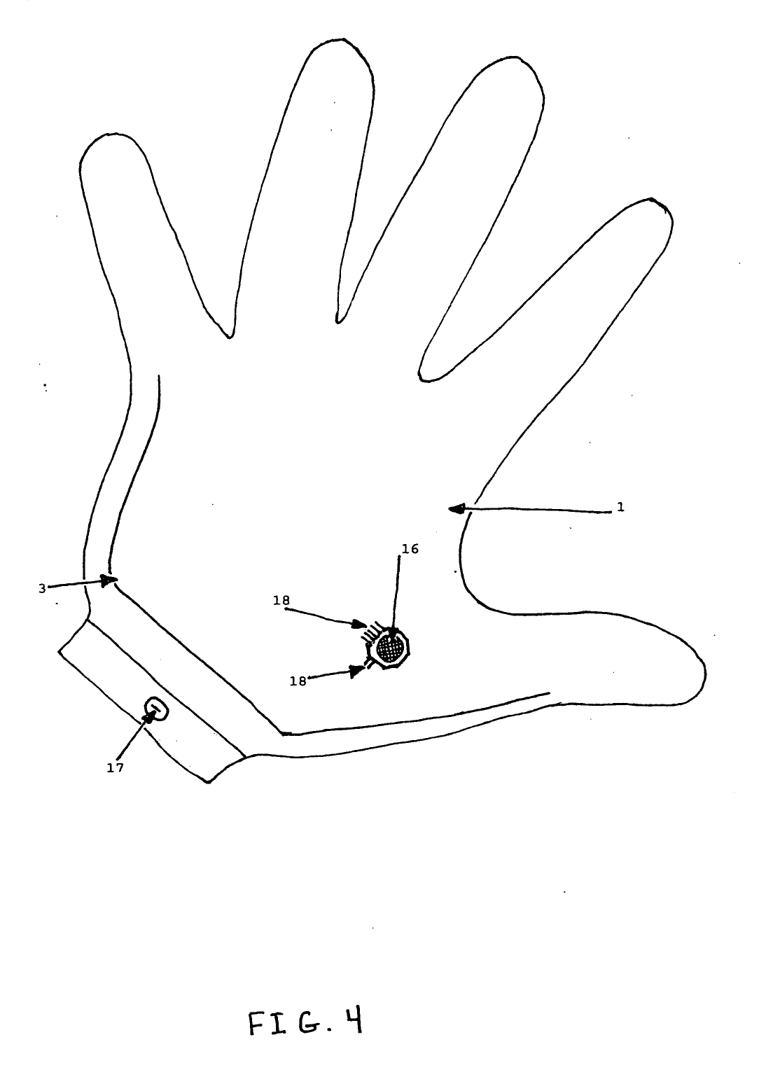

FIG. 4 shows the glove 1, including the polyurethane 3, the detail of the on/off switch 16, and the wire connectors 20 for the wires leading to the LEDs and to the battery, as well as the (in this case, negative) magnet on the wristband 17.

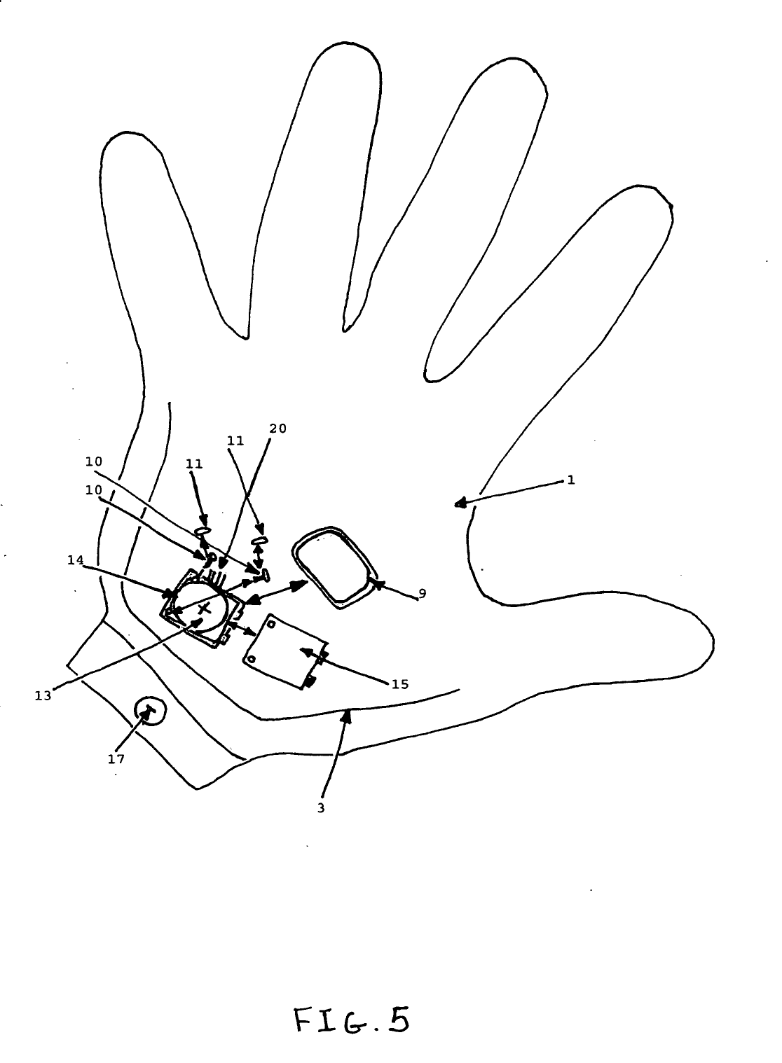

FIG. 5 shows another view of the battery housing 14, cover 15, O-ring gasket 9, screws 10, O-rings 11, and the battery 13, showing the wire connectors 20 for the wires leading to the on/off switch. The polyurethane 3 and magnet 17 are shown as well.

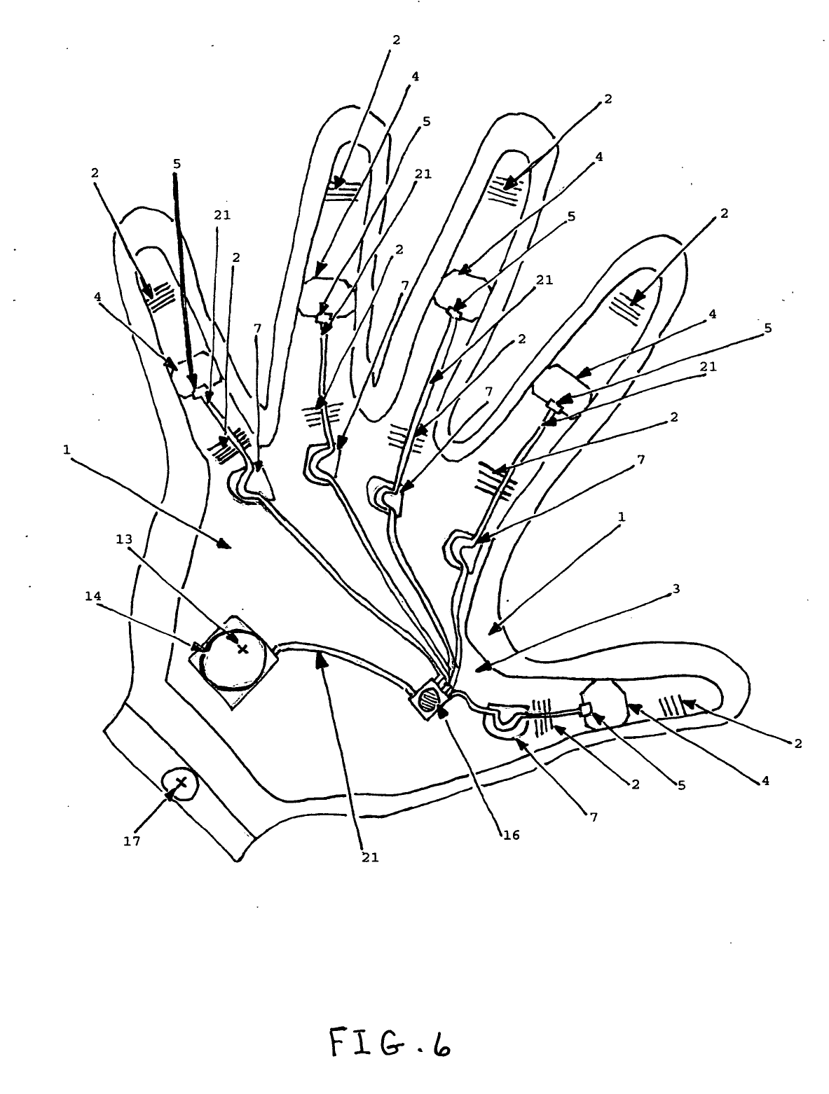

FIG. 6 includes all details shown in FIGS. 1-5, with the addition of the wiring 21 between the battery, on/off switch and LED lights.

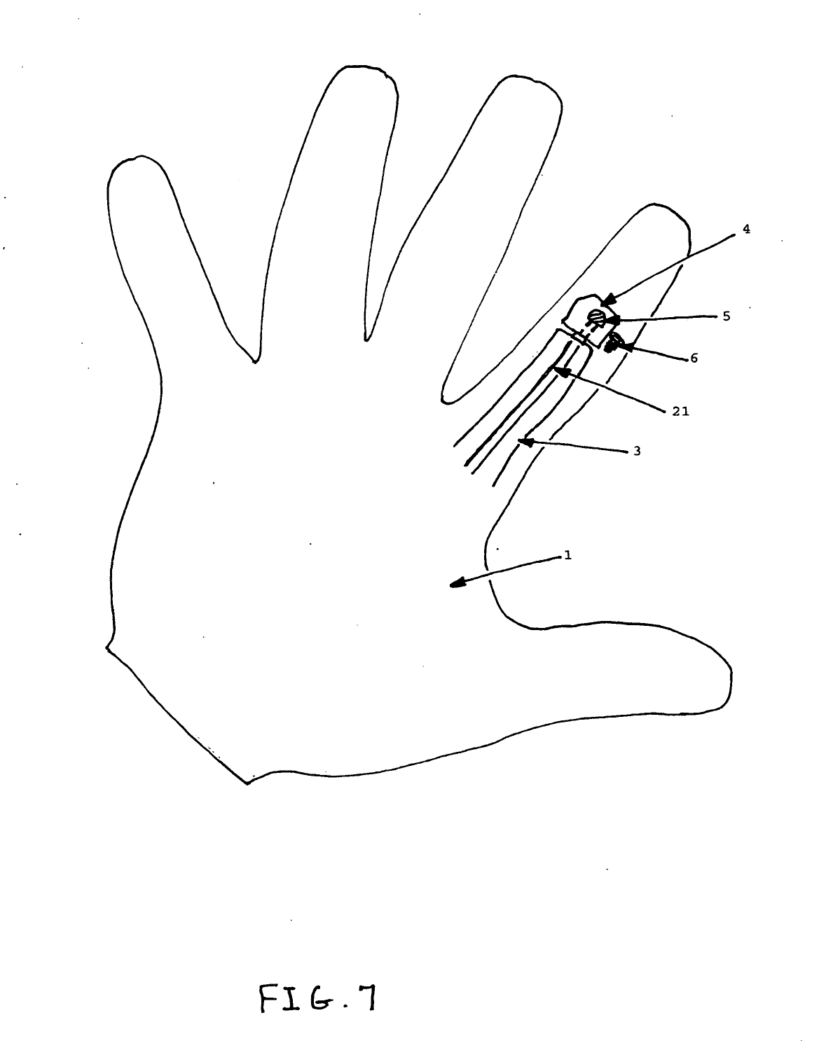

FIG. 7 is detail for one finger of the glove, showing the wiring 21 leading to the LED 5, O-ring rubber gasket 6, as well as the sliver painted reflector 4.

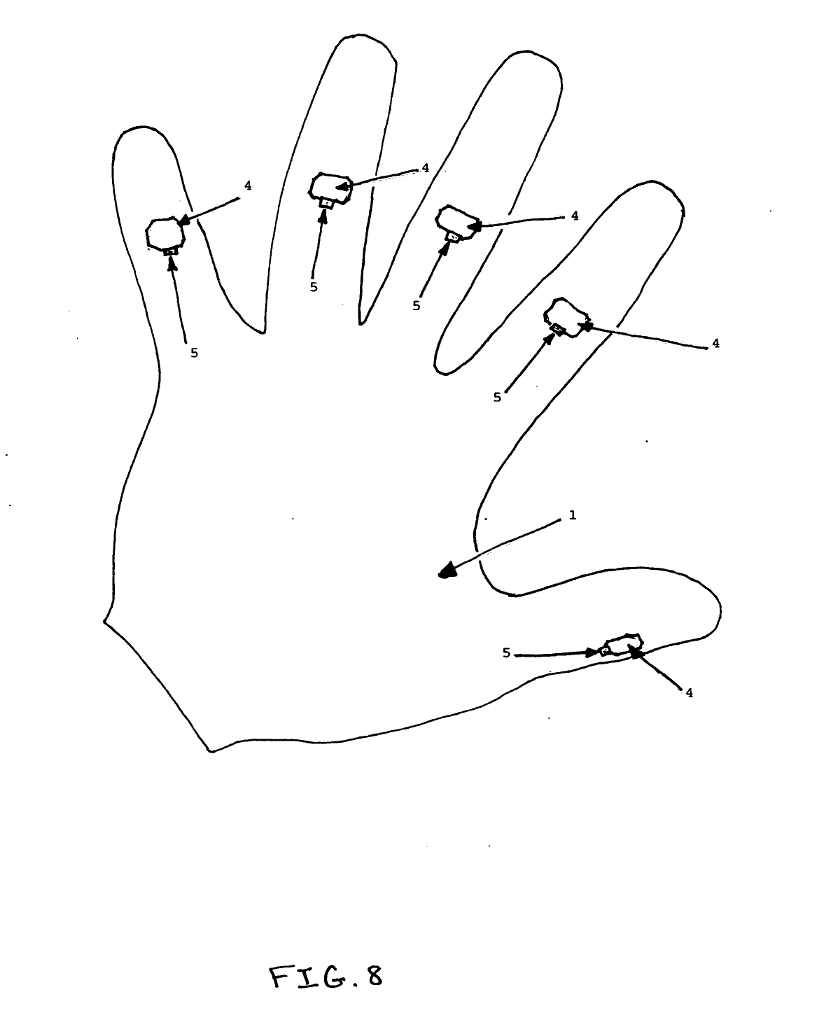

FIG. 8 shows the detail of the LEDs 5 and the silver painted reflectors 4.

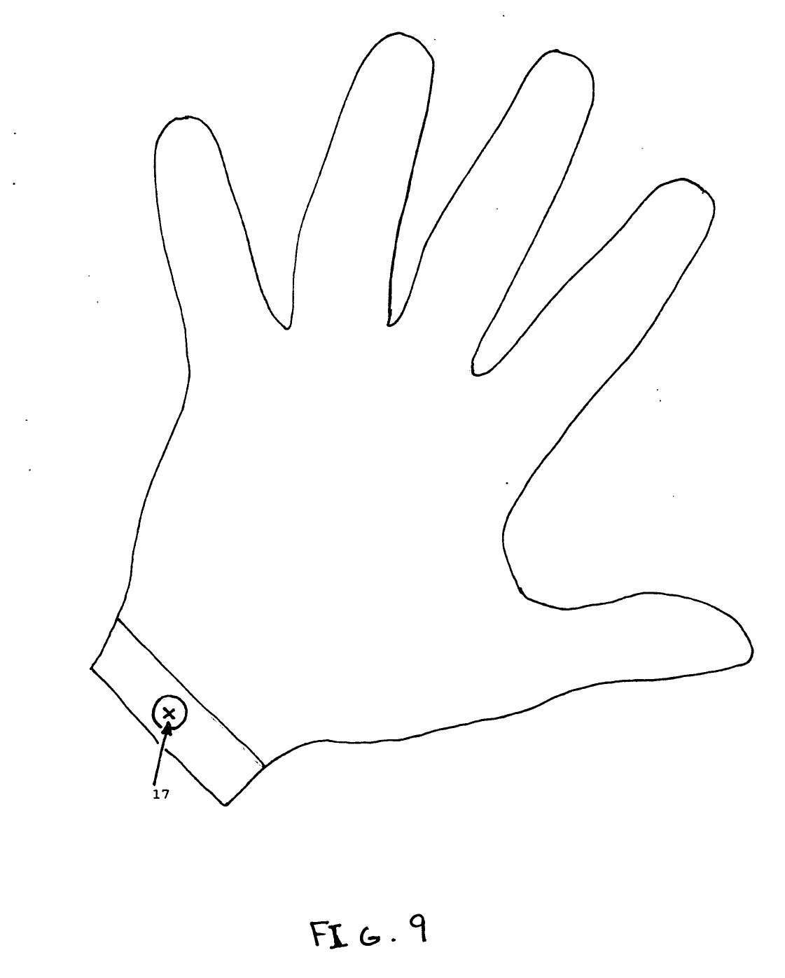

FIG. 9 shows the positive magnet 17 on the wristband of a glove.

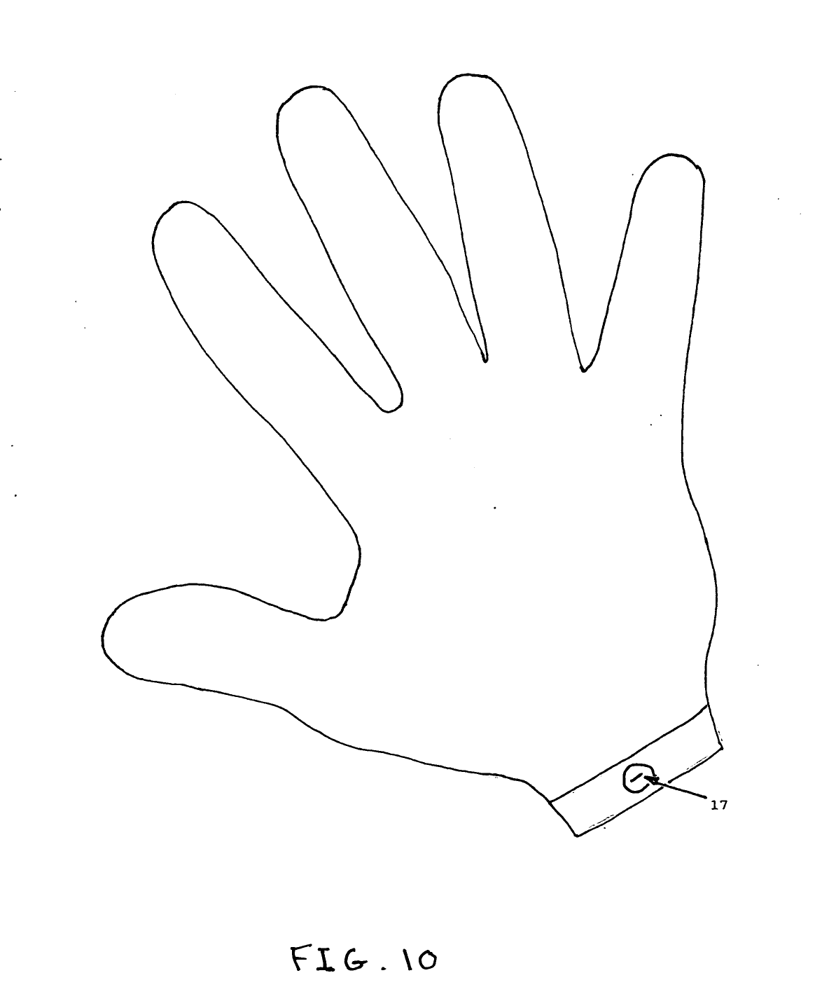

FIG. 10 shows the negative magnet 17 on the wristband of a glove.

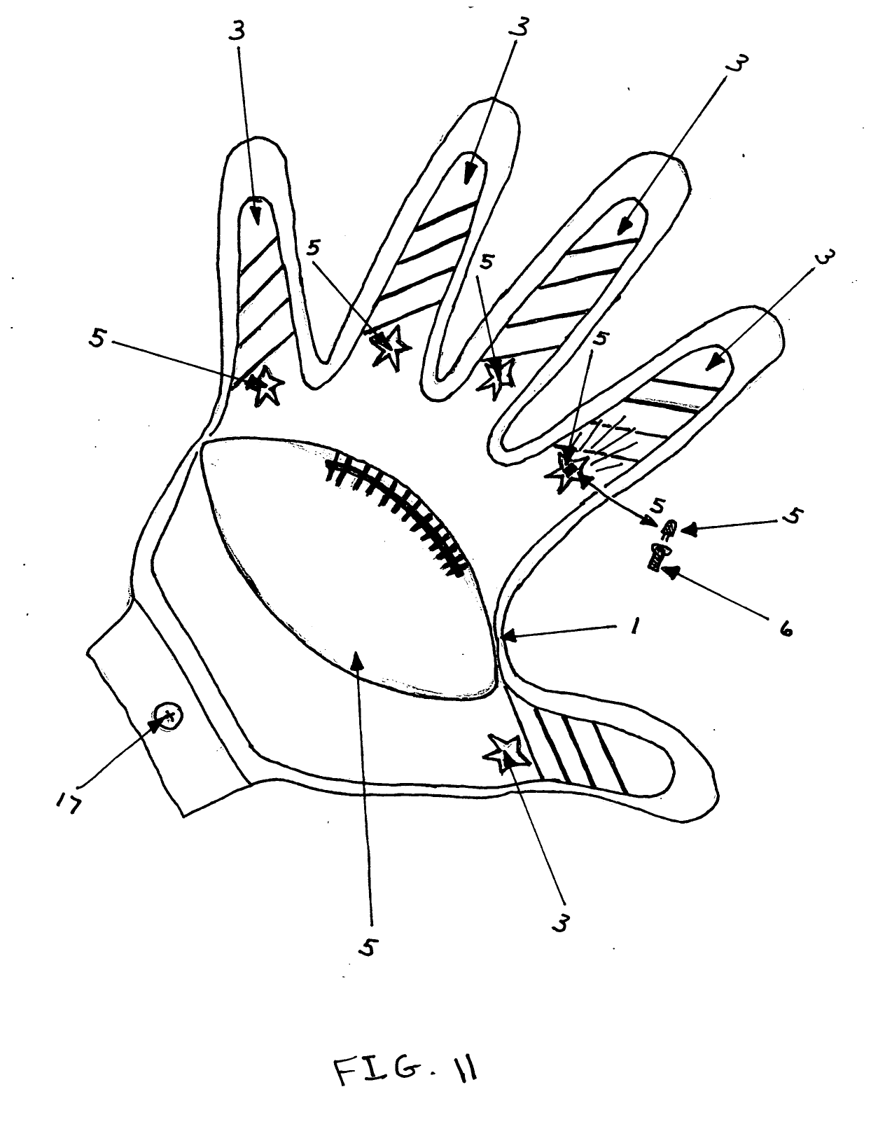

FIG. 11 is a second embodiment of the apparatus shows examples of decorative designs on the first knuckles and back of glove made from polyurethane models; the LEDs 5 are incorporated into the models, and are shown with the O-ring rubber gaskets 6 that fit over the LEDs to keep them waterproofed. This apparatus is structurally the same as the first embodiment; these decorative designs are not meant to be an exhaustive list and we are not seeking to patent these designs. These gloves, while suited for work, may also be attractive in appropriate sizes for children, as well as for adults.

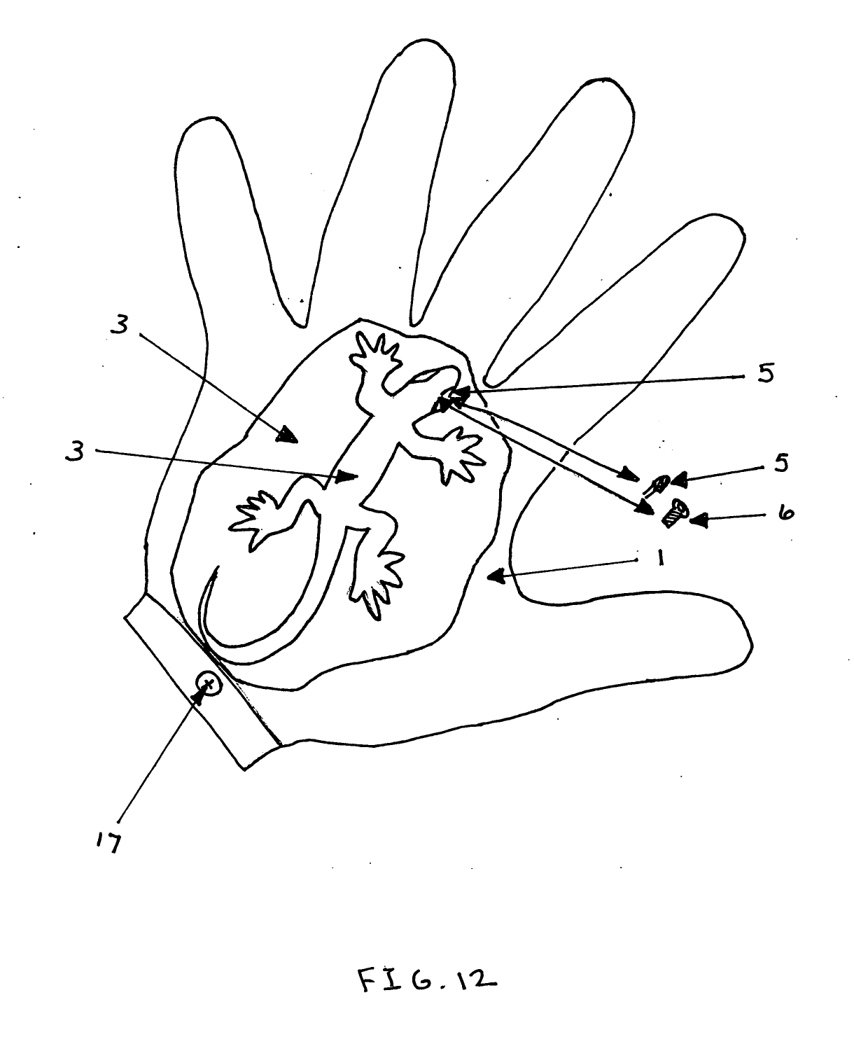

FIG. 12 shows a lizard sitting on a leaf as another example of a design; this design includes LEDs 5 on the finger(s) and also on the back of the glove. This design also is not meant to be exclusive of other designs not shown in these figures. We are not intending to patent these designs.

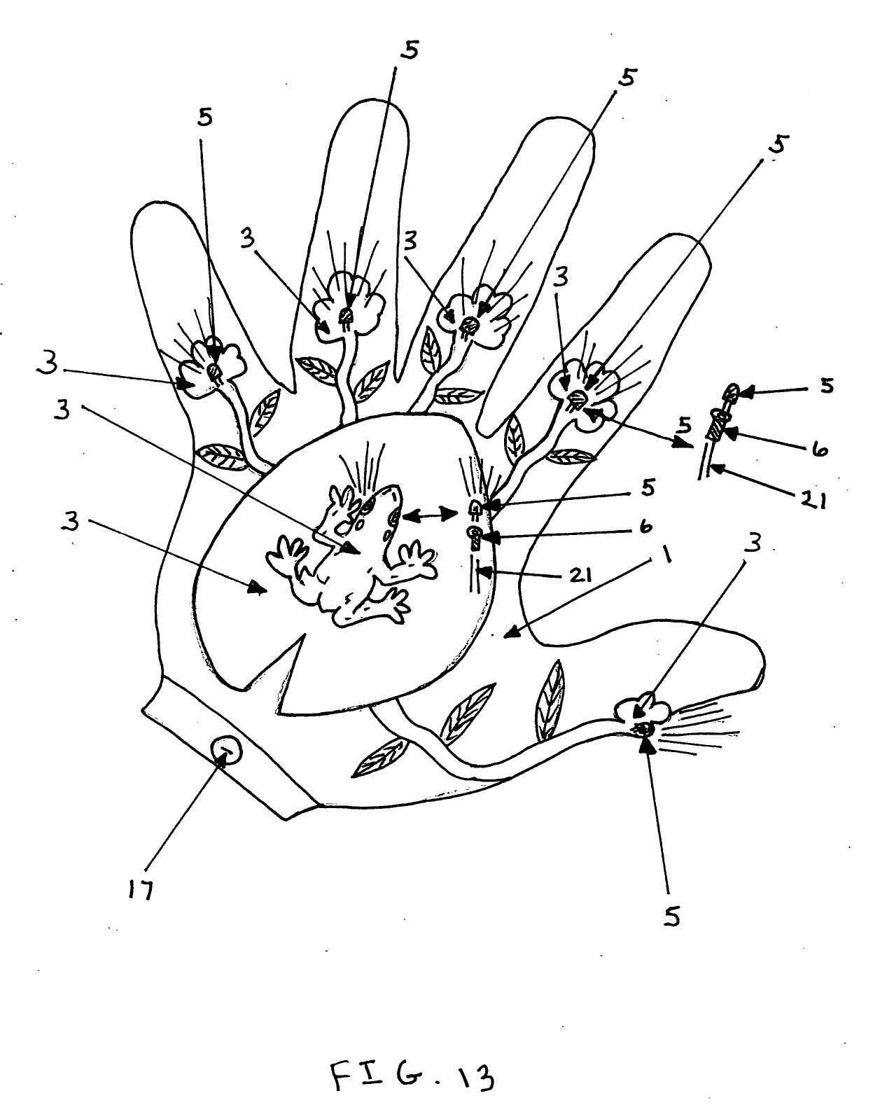

FIG. 13 shows another example of a design incorporating LEDs 5 on fingers and on the back of the glove; this design, a frog on a leaf on the back of the glove with flower designs on the fingers is also not meant to be exclusive of other designs not shown in these figures and we are not seeking to patent these designs.

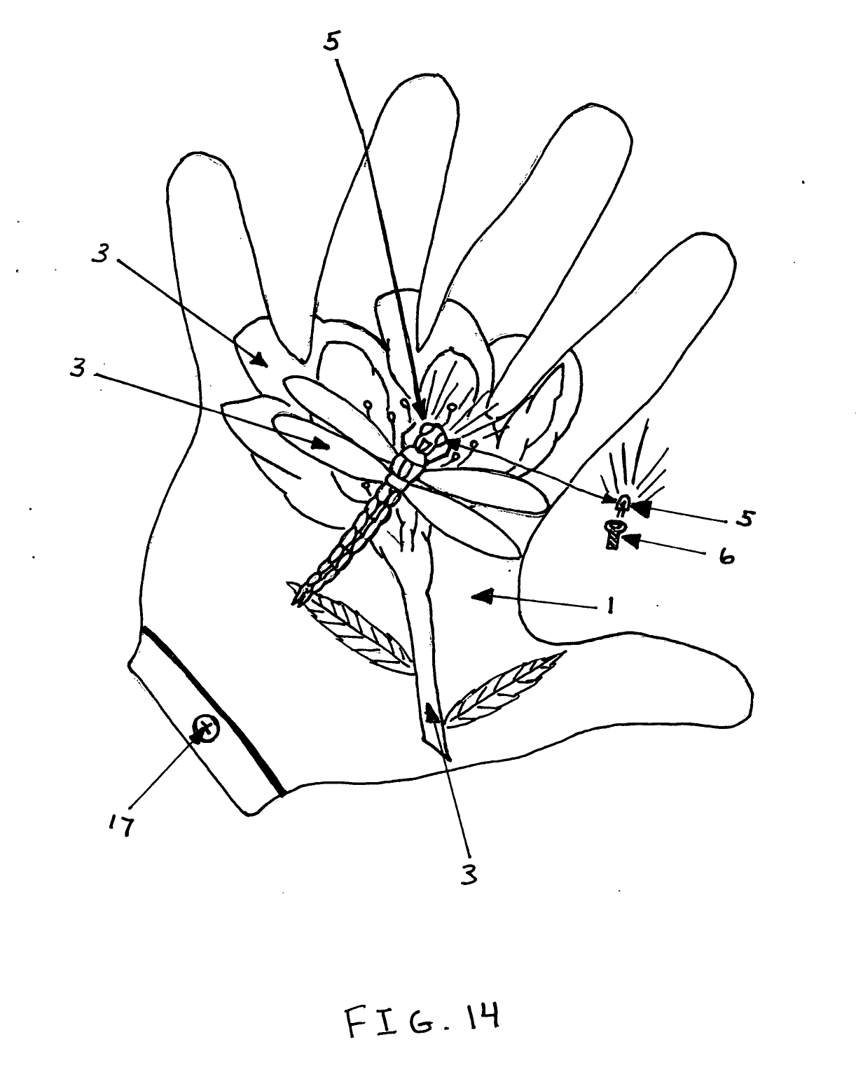

FIG. 14 shows a butterfly with leaves on the back of the glove and fingers as another design incorporating LEDs 5. It is illustrative of the decorative possibilities, but is not meant to be exclusive of others. We are not seeking to patent it.

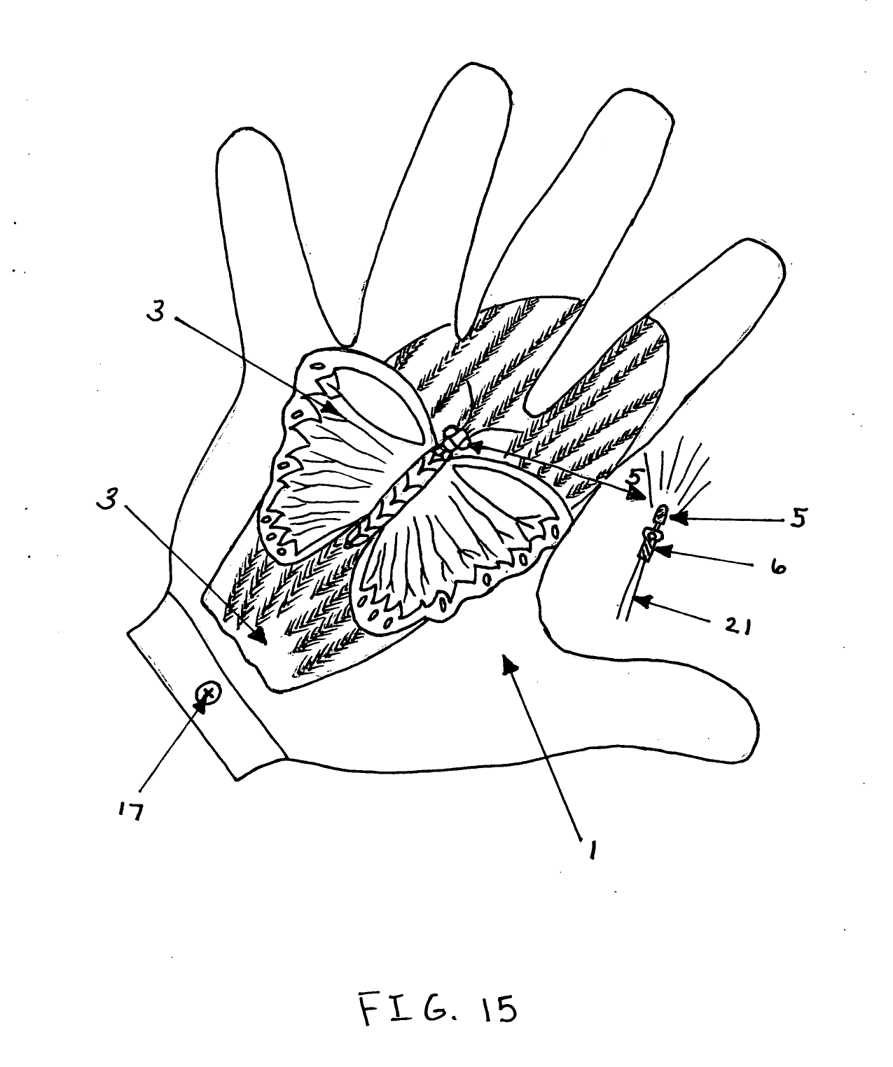

FIG. 15 shows a dragonfly on the back of the glove and fingers as another design incorporating LEDs 5. It is illustrative, but is not meant to be exclusive of others and we are not seeking to patent the design.

While particular embodiments of the invention have been shown, and described, numerous variations and alternate embodiments will occur to those skilled in the art. Accordingly, it is intended that the invention be limited only in terms of the appended claims:

We claim:

1. An apparatus for illuminating a work area or other dark or dimly lit area, comprising:
a. a glove to be worn on a user's hand, with an interior surface adjacent to the hand and an external surface having knuckle portions;
b. the glove being covered in polyurethane;
c. the glove having slotted cutouts at the first knuckle of each finger to provide flexibility;
d. the glove having light-emitting diodes (LEDs) at the second knuckle of each finger and thumb;
e. the glove having a small silver painted reflector positioned such that when light from the LED hits the reflector, it shines toward where the finger is pointed in order to maximize illumination;
f. the reflector described in 1e is formed by a little ridge in the polyurethane, creating an angle so as to direct the light toward the target.
g. an O-ring rubber gasket with threads that screws in over the LED to seal it and ensure it is waterproofed;
h. wires to the LED that run from an off/on switch along a channel which forms a cavity to provide for flexibility for hand flexing motions;
i. a battery that fits in a housing with a cover that is connected by screws with O-rings to provide waterproofing;
j. plastic pieces on the battery housing cover and latches on the battery housing to close it;
k. an O-ring gasket that goes around the housing to seal and waterproof it;
l. an on/off switch;
m. wire connectors and wires leading from the on/off switch to the battery;
n. wire connectors and wires leading from the on/off switch to the LEDs.

2. an embodiment of the apparatus described in 1 that includes magnets on each glove to facilitate attachment to prevent the gloves from getting separated and lost during storage;

3. an embodiment of the apparatus described in 1 and in 2 that includes decorative designs of various types made from polyurethane models on the back of the glove and/or on fingers of the glove;

4. an embodiment of the apparatus described in 3 that includes LEDs, O-ring rubber gaskets and reflectors as needed as part of these designs;
